(19) United States
(12) Patent Application Publication
(10) Pub. No.: US 2017/0018772 A1
(43) Pub. Date: Jan. 19, 2017

(54) POSITIVE ELECTRODE ACTIVE MATERIAL FOR NONAQUEOUS ELECTROLYTE SECONDARY BATTERY AND POSITIVE ELECTRODE FOR NONAQUEOUS ELECTROLYTE SECONDARY BATTERY

(71) Applicant: SANYO Electric Co., Ltd., Daito-shi (JP)

(72) Inventors: Taiki Satow, Hyogo (JP); Takeshi Ogasawara, Hyogo (JP); Taizou Sunano, Osaka (JP)

(73) Assignee: SANYO Electric Co., Ltd., Daito-shi (JP)

(21) Appl. No.: 15/124,164

(22) PCT Filed: Mar. 5, 2015
(86) PCT No.: PCT/JP2015/001165

§ 371 Date: Sep. 7, 2016

(30) Foreign Application Priority Data
Mar. 11, 2014 (JP) 2014-047175

(51) Int. Cl. H01M 4/525; H01M 10/0525; C01F 17/00; H01M 4/36; H01M 4/131; C01G 51/00; H01M 4/62; H01M 4/38

(52) U.S. Cl. CPC H01M 4/525; H01M 4/621; H01M 4/624; H01M 10/0525; H01M 4/38; H01M 4/366; H01M 4/131; C01G 51/40; C01F 17/0043; H01M 2004/028

(57) ABSTRACT

Dissolution of cobalt from a positive electrode active material is suppressed. Disclosed is a positive electrode active material for a nonaqueous electrolyte secondary battery that contains a lithium transition metal oxide. Fluorine and at least one element selected from zirconium, titanium, aluminum, magnesium, and rare earth elements adhere to the surface of the lithium transition metal oxide, and the lithium transition metal oxide contains cobalt. The lithium transition metal oxide has an average particle diameter of 10 μm or less.

### TECHNICAL FIELD

The present invention relates to a positive electrode active material for a nonaqueous electrolyte secondary battery and to a positive electrode for a nonaqueous electrolyte secondary battery.

### BACKGROUND ART

The energy density and output power of a lithium ion battery can be increased by increasing the capacity of an active material or increasing the filling amount of the active material per unit volume and can also be increased by increasing the charge voltage of the battery. However, when the charge voltage of the battery is increased, a problem arises in that the electrolyte is more likely to decompose. In particular, when the battery is stored at high temperature or undergoes repeated charge-discharge cycles at high temperature, another problem arises in that the discharge capacity decreases.

In view of the above problems, it has been proposed to modify the surface of the positive electrode active material. For example, PTL 1 proposes a positive electrode active material for a lithium secondary battery that has a surface coated with AlF₃, ZnF₂, etc.

PTL 2 proposes that the surface of positive electrode active material particles is coated with lanthanoid oxide to improve the chemical stability of the active material.

### CITATION LIST

### Patent Literature

PTL 1: Japanese Published Unexamined Patent Application (Translation of PCT Application) No. 2008-536285

PTL 2: Japanese Published Unexamined Patent Application No. 2009-4316

### SUMMARY OF INVENTION

### Technical Problem

A problem with the techniques disclosed in PTL 1 and PTL 2 is that the properties of the battery cannot be improved sufficiently when the positive electrode active material used has a small particle diameter.

### Solution to Problem

To solve the foregoing problem, the nonaqueous electrolyte secondary battery positive electrode active material according to the present invention is a positive electrode active material for a nonaqueous electrolyte secondary battery that includes a lithium transition metal oxide. Fluorine and at least one element selected from zirconium, titanium, aluminum, magnesium, and rare earth elements adhere to the surface of the lithium transition metal oxide, and the lithium transition metal oxide contains cobalt. The lithium transition metal oxide has an average particle diameter of 10 μm or less.

The positive electrode for a nonaqueous electrolyte secondary battery according to the present invention includes the positive electrode active material for a nonaqueous electrolyte secondary battery, a conductive agent, and a binder.

### Advantageous Effects of Invention

Even when the inventive positive electrode active material and inventive positive electrode for a nonaqueous electrolyte secondary battery are subjected to high temperature with the battery charged, dissolution of cobalt from the positive electrode active material is suppressed.

### BRIEF DESCRIPTION OF DRAWINGS

FIG. 1 is an illustration showing the surface state of lithium cobaltate that is one example of an embodiment of the present invention.

FIG. 2 is a graph showing the results of experiments 1 to 8.

### DESCRIPTION OF EMBODIMENTS

One example of an embodiment of the present invention will next be described in detail. The drawings referred to in the description of the embodiment are schematic drawings, and the dimensional ratios etc. of components drawn in the drawings may be different from those of actual components. Specific dimensional ratios etc. should be determined in consideration of the following description.

A nonaqueous electrolyte secondary battery according to one example of the embodiment of the present invention includes a positive electrode containing a positive electrode active material, a negative electrode containing a negative electrode active material, a nonaqueous electrolyte containing a nonaqueous solvent, and a separator. An example of the nonaqueous electrolyte secondary battery is a structure in which the nonaqueous electrolyte and an electrode assembly prepared by winding the positive electrode and the negative electrode through the separator are contained in an exterior member.

### [Positive Electrode]

Preferably, the positive electrode includes a positive electrode current collector and a positive electrode active material layer formed on the positive electrode current collector. The positive electrode current collector used is, for example, a conductive thin film, particularly a metal or alloy foil such as an aluminum foil stable within the potential range of the positive electrode or a film having a metal surface layer such as an aluminum surface layer. Preferably, the positive electrode active material layer contains, in addition to the positive electrode active material, a conductive agent and a binder.

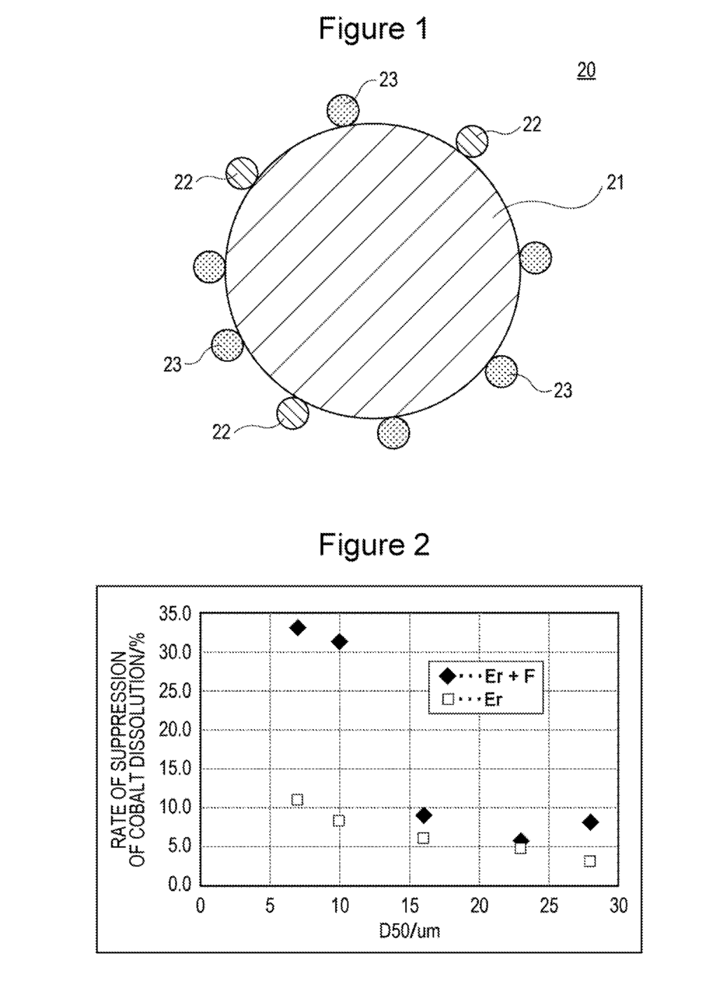

As shown in FIG. 1, the positive electrode active material 20 includes lithium-cobalt transition metal oxide particles 21, a material 22 containing at least one element selected from zirconium, titanium, aluminum, magnesium, and rare earth elements (hereinafter may be referred to simply as the material 22), and a material 23 containing fluorine (hereinafter may be referred to simply as the material 23), the material 22 and the material 23 adhering to part of the surface of the lithium-cobalt transition metal oxide particles 21.

The average particle diameter of the lithium-cobalt transition metal oxide particles 21 is preferably 10 μm or less and more preferably 7 μm or less. When the material 22 containing at least one element selected from zirconium, titanium, aluminum, magnesium, and rare earth elements and the material 23 containing fluorine adhere to the surface of the lithium-cobalt transition metal oxide particles 21 having an average particle diameter of 10 μm or less, dissolution of cobalt in the electrolyte in a charged state can be significantly suppressed.

The average particle diameter of the lithium-cobalt transition metal oxide particles 21 is preferably 2 μm or more and more preferably 4 μm or more. If the average particle diameter is less than 2 μm, the total surface area of the lithium-cobalt transition metal oxide particles 21 becomes large, so that the ratio the area of the lithium-cobalt transition metal oxide particles 21 that is covered with the adhering substances to the total surface area tends to decrease.

The average particle diameter of the lithium-cobalt transition metal oxide particles 21 means a particle diameter (volume average particle diameter: Dv₅₀) at a cumulative volume of 50% in a particle size distribution measured by a laser diffraction scattering method. This Dv₅₀ can be measured, for example, by “LA-750” manufactured by HORIBA, Ltd.

Preferably, the lithium-cobalt transition metal oxide contains cobalt in an amount of 80% by mole or more with respect to the total amount of transition metals in the lithium-cobalt transition metal oxide. Examples of the lithium-cobalt transition metal oxide include lithium transition metal oxides such as lithium cobaltate, Ni—Co—Mn, and Ni—Co—Al. Of these, lithium cobaltate is preferred. The lithium-cobalt transition metal oxide may contain substances such as Al, Mg, Ti, and Zr present in the form of solid solution or at grain boundaries.

Preferably, the material 22 is particles having an average particle diameter of 100 nm or less. More preferably, the material 22 is particles having an average particle diameter of 50 nm or less. If the material 22 has an average particle diameter exceeding 100 nm, the material 22 adheres to the lithium-cobalt transition metal oxide particles 21 in smaller areas than those with the material 22 having an average particle diameter of 100 nm or less even when their amounts are the same, so that the above-described effect may not be sufficiently obtained. The lower limit of the average particle diameter of the material 22 is preferably 0.1 nm or more and particularly preferably 1 nm or more. If the average particle diameter is less than 0.1 nm, the surface of the positive electrode active material is excessively covered with the material 22.

Preferably, the material 22 is at least one selected from hydroxides, oxyhydroxides, and carbonate compounds that contain at least one element selected from zirconium, titanium, aluminum, magnesium, and rare earth elements. The material 22 may contain fluorine.

The amount of adhesion of the material 22 in terms of zirconium, titanium, aluminum, magnesium, and rare earth elements with respect to the total mass of the lithium transition metal oxide is preferably from 0.005% by mass to 0.5% by mass inclusive and more preferably from 0.05% by mass to 0.3% by mass inclusive. This is because, if the amount of adhesion is less than 0.05% by mass, the effect of suppressing dissolution of cobalt is not obtained sufficiently. If the amount of adhesion exceeds 0.5% by mass, the amount of the adhering substances on the surface becomes excessively large, and this may cause an excessive increase in resistance, resulting in a reduction in discharge properties.

The average particle diameter of the material 23 is preferably 500 nm or less and more preferably 300 nm or less.

This is because, if the average particle diameter is excessively large, the surface is excessively covered with a fluorine compound having low electron conductivity, and this may cause a reduction in discharge properties. The lower limit of the average particle diameter of the material 23 is preferably 50 nm or more and particularly preferably 100 nm or more. If the average particle diameter is less than 100 nm, the cobalt dissolution suppressing effect of the material 23 containing elemental fluorine and the metal element in the material 22 may not be obtained sufficiently.

The material 23 may be composed only of elemental fluorine. The material 23 is preferably a compound containing an alkali metal and fluorine and is more preferably at least one selected from lithium fluoride, sodium fluoride, and potassium fluoride. The material 23 may contain any of zirconium, titanium, aluminum, magnesium, and rare earth elements.

Preferably, the average particle diameter of the material 23 is larger than the average particle diameter of the material 22.

The amount of adhesion of the material 23 in terms of the elemental fluorine with respect to the total mass of the lithium transition metal oxide is preferably from 0.005% by mass to 1.0% by mass inclusive and particularly preferably from 0.01% by mass to 0.5% by mass inclusive.

The molar ratio of the total amount of the at least one element selected from zirconium, titanium, aluminum, magnesium, and rare earth elements to the total amount of the elemental fluorine that are contained in the materials 22 and 23 adhering to the lithium-cobalt transition metal oxide particles 21 is preferably 1:2 to 1:4. When the molar ratio is within the above range, the metal element in the material 22 and the elemental fluorine in the material 23 can easily interact with each other, so that dissolution of cobalt from lattice defects can be suppressed.

The size of the material 22 containing at least one element selected from zirconium, titanium, aluminum, magnesium, and rare earth elements and the size of the material 23 containing fluorine are values when they are observed under a scanning electron microscope (SEM).

At least one selected from scandium, yttrium, lanthanum, cerium, praseodymium, neodymium, samarium, europium, gadolinium, terbium, dysprosium, holmium, erbium, thulium, ytterbium, and lutetium may be used as the rare earth element. Particularly, neodymium, samarium, erbium, and lanthanum are used preferably.

Fluorine and at least one element selected from zirconium, titanium, aluminum, magnesium, and rare earth elements can be caused to adhere to the surface of the lithium-cobalt transition metal oxide particles 21 using, for example, a method including causing a hydroxide, an oxyhydroxide, or a carbonate compound containing a rare earth element, zirconium, magnesium, titanium, or aluminum to the positive electrode active material and then spraying an aqueous solution containing fluorine onto the resulting positive electrode active material. For example, NH₄F, NaF, or KF may be preferably used as the solute of the aqueous solution containing fluorine.

One type of positive electrode active material 20 may be used alone, or a mixture of a plurality of types may be used. A mixture of the positive electrode active material 20 with a positive electrode active material containing no Co may be used. The ratio of the positive electrode active material 20 to the total amount of the positive electrode active materials is preferably from 20% by mass to 100% by mass inclusive. When the ratio of the positive electrode active material 20 is 20% by mass or more, the above-described effect of suppressing dissolution of cobalt in the electrolyte can be obtained sufficiently.

### [Negative Electrode]

Preferably, the negative electrode includes a negative electrode current collector and a negative electrode active material layer formed on the negative electrode current collector. The negative electrode current collector used is for example, a conductive thin film, particularly a metal or alloy foil such as a copper foil stable within the potential range of the negative electrode or a film having a metal surface layer such as a copper surface layer. Preferably, the negative electrode mixture layer contains, in addition to the negative electrode active material, a binder. The binder used may be polytetrafluoroethylene etc., as in the case of the positive electrode, but is preferably styrene-butadiene rubber (SBR), polyimide, etc. The binder may be used in combination with a thickener such as carboxymethyl cellulose.

Examples of the negative electrode active material include carbon materials that can occlude and release lithium, metals that can form alloys with lithium, and alloy compounds containing these metals. The carbon material used may be graphite such as natural graphite, non-graphitizable carbon, or artificial graphite or coke. Examples of the alloy compound include compounds containing at least one metal that can be alloyed with lithium. In particular, the element that can be alloyed with lithium is preferably silicon or tin, and silicon oxide, tin oxide, etc. produced by bonding oxygen to these elements may also be used. A mixture of the above carbon material and a silicon or tin compound may also be used. In addition to the above materials, materials, such as lithium titanate, having a higher charge/discharge potential with respect to metal lithium than the carbon materials etc. may be used as the negative electrode material, although the energy density becomes low.

[Nonaqueous Electrolyte]

Examples of the electrolyte salt used for the nonaqueous electrolyte include LiClO₄, LiBF₄, LiPF₆, LiAlCl₄, LiSbF₆, LiSCN, LiCF₃SO₃, LiCF₃CO₂, LiAsF₆, LiB₁₀Co₁₀, lower aliphatic lithium carboxylates, LiCl, LiBr, LiI, chloroborane lithium, borates, and imidates. Of these, LiPFe is used preferably from the viewpoint of ionic conductivity and electrochemical stability. One type of electrolyte salt may be used alone, or a combination of two or more types may be used. Preferably, the electrolyte salt is contained at a ratio of 0.8 to 1.5 moles per liter of the nonaqueous electrolyte.

The solvent used for the nonaqueous electrolyte is, for example, a cyclic carbonate, a chain carbonate, a cyclic carboxylate, etc. Examples of the cyclic carbonate include propylene carbonate (PC), ethylene carbonate (EC), and fluoroethylene carbonate (FEC). Examples of the chain carbonate include diethyl carbonate (DEC), ethyl methyl carbonate (EMC), and dimethyl carbonate (DMC). Examples of the cyclic carboxylate include γ-butyrolactone (GBL) and γ-valerolactone (GVL). Examples of the chain carboxylate include methyl propionate (MP) and fluoromethyl propionate (FMP). One type of nonaqueous solvent may be used alone, or a combination of two or more types may be used.

### [Separator]

The separator used is a porous sheet having ion permeability and insulating properties. Specific examples of the porous sheet include microporous films, woven fabrics, and nonwoven fabrics. The material of the separator is preferably a polyolefin such as polyethylene or polypropylene.

### EXAMPLES

### Experiment 1

### [Production of Positive Electrode]

500 g of lithium cobaltate particles (average particle diameter: 7 μm) in which 1.5% by mole of Mg and 1.5% by mole of Al with respect to the lithium cobaltate were present in the form of solid solution were prepared. The lithium cobaltate particles were added to 1.5 L of pure water, and then an aqueous solution prepared by dissolving 1.13 g of erbium nitrate pentahydrate (Er(NO₃)₃.5H₂O) in 100 mL of pure water was added thereto under stirring. In this case, a 10% by mass aqueous sodium hydroxide solution was appropriately added such that the pH of the resulting solution became 9 (the pH was maintained at 9) to thereby allow erbium hydroxide to adhere to the surface of the lithium cobaltate particles. The resultant solution was subjected to suction filtration to collect the treated product, and the treated product was dried at 120° C. to thereby obtain lithium cobaltate particles with the erbium hydroxide adhering to and dispersed on their surface.

Next, an aqueous solution prepared by dissolving 0.28 g of ammonium fluoride (NH₄F) in 25 g of pure water was sprayed while the obtained positive electrode active material was stirred. Then the resulting positive electrode active material was subjected to heat treatment in air at 400° C. for 6 hours.

The obtained positive electrode active material was observed under a scanning electron microscope (SEM), and particles containing erbium and a compound containing fluorine (lithium fluoride) were found to adhere to part of the surface of the lithium cobaltate. The average particle diameter of the particles containing erbium was 100 nm or less. The size of the compound containing fluorine was 200 nm or less. The amount of adhesion of erbium was measured by ICP and found to be 0.085% by mass with respect to the lithium cobaltate. The amount of fluorine was measured by ion chromatography and found to be 0.029% by mass with respect to the lithium cobaltate, and the molar ratio of erbium to F was 1:3.

The obtained positive electrode active material, acetylene black powder, and polyvinylidene fluoride at a mass ratio of 95:2.5:2.5 were kneaded in an N-methyl-2-pyrrolidone (NMP) solution to prepare a positive electrode mixture slurry. Next, the positive electrode mixture slurry was applied uniformly to both sides of a positive electrode current collector formed from an aluminum foil, dried, and then rolled by rollers to thereby produce a positive electrode including a positive electrode mixture layer formed on both sides of the positive electrode current collector. The filling density of the active material in the positive electrode was 3.2 g/cm³.

### [Production of Negative Electrode]

Artificial graphite used as the negative electrode active material, sodium carboxymethyl cellulose, and styrene-butadiene rubber at a mass ratio of 98:1:1 were mixed in an aqueous solution to prepare a negative electrode mixture slurry. Then the negative electrode mixture slurry was applied uniformly to both sides of a negative electrode current collector formed from a copper foil, dried, and then rolled by rollers to thereby obtain a negative electrode including a negative electrode mixture layer formed on both sides of the negative electrode current collector. The filling density of the active material in the negative electrode was 1.65 g/cm³.

### [Preparation of Nonaqueous Electrolyte]

Ethylene carbonate (EC), methyl ethyl carbonate (MEC), and diethyl carbonate (DEC) were mixed at a volume ratio of 3:5:2 to prepare a solvent mixture, and lithium hexafluorophosphate (LiPF₆) was dissolved in the solvent mixture at a concentration of 1.0 mol/L to prepare a nonaqueous electrolyte (nonaqueous electrolyte solution).

### [Production of Battery]

Lead terminals were attached to the positive and negative electrodes. These electrodes were spirally wound around a core with a separator disposed therebetween, and the core was pulled out to thereby produce a spiral electrode assembly. Then the electrode assembly was flattened to obtain a flat electrode assembly. Next, the flat electrode assembly and the nonaqueous electrolyte solution were inserted into an exterior member formed from an aluminum laminate, and the exterior member was sealed to produce a battery A1. The design capacity of the battery A1 (the discharge capacity when the battery was charged to 4.40 V and discharged to 2.75 V) was 750 mAh.

### Experiment 2

A battery A2 was produced in the same manner as in experiment 1 except that lithium cobaltate (average particle diameter: 10 μm) was used for the positive electrode active material.

### Experiment 3

A battery B1 was produced in the same manner as in experiment 1 except that lithium cobaltate (average particle diameter: 16 μm) was used for the positive electrode active material.

### Experiment 4

A battery B2 was produced in the same manner as in experiment 1 except that lithium cobaltate (average particle diameter: 23 μm) was used for the positive electrode active material.

### Experiment 5

A battery B3 was produced in the same manner as in experiment 1 except that lithium cobaltate (average particle diameter: 28 μm) was used for the positive electrode active material.

### Experiment 6

A battery C1 was produced in the same manner as in experiment 1 except that lithium cobaltate particles including erbium hydroxide dispersed on and adhering to their surface (i.e., lithium cobaltate particles including erbium hydroxide dispersed on and adhering to their surface but including no fluorine adhering to the surface) were used as the positive electrode active material.

### Experiment 7

A battery C2 was produced in the same manner as in experiment 6 except that lithium cobaltate (average particle diameter: 10 μm) was used for the positive electrode active material.

### Experiment 8

A battery D1 was produced in the same manner as in experiment 6 except that lithium cobaltate (average particle diameter: 16 μm) was used for the positive electrode active material.

### Experiment 9

A battery D2 was produced in the same manner as in experiment 6 except that lithium cobaltate (average particle diameter: 23 μm) was used for the positive electrode active material.

### Experiment 10

A battery D3 was produced in the same manner as in experiment 6 except that lithium cobaltate (average particle diameter: 28 μm) was used for the positive electrode active material.

### Experimental Example 11

A battery E1 was produced in the same manner as in experiment 2 except that 1.14 g of samarium nitrate hexahydrate (Sm(NO₃)₃.6H₂O) was used instead of erbium nitrate pentahydrate. The amount of adhesion of samarium and the amount of adhesion of fluorine were 0.085% by mass and 0.029% by mass, respectively, and the molar ratio of samarium to fluorine was 1:3.

### Experimental Example 12

A battery F1 was produced in the same manner as in experiment 2 except that 1.12 g of neodymium nitrate hexahydrate (Nd(NO₃)₃.6H₂O) was used instead of erbium nitrate pentahydrate. The amount of adhesion of neodymium and the amount of adhesion of fluorine were 0.074% by mass and 0.029% by mass, respectively, and the molar ratio of neodymium to fluorine was 1:3.

### Experimental Example 13

A battery G1 was produced in the same manner as in experiment 2 except that 1.11 g of lanthanum nitrate hexahydrate (La(NO₃)₃.6H₂O) was used instead of erbium nitrate pentahydrate. The amount of adhesion of lanthanum and the amount of adhesion of fluorine were 0.071% by mass and 0.029% by mass, respectively, and the molar ratio of lanthanum to fluorine was 1:3.

### Experimental Example 14

A battery H1 was produced in the same manner as in experiment 2 except that 1.10 g of zirconium nitrate pentahydrate (Zr(NO₃)₄.5H₂O) was used instead of erbium nitrate pentahydrate. The amount of adhesion of zirconium and the amount of adhesion of fluorine were 0.046% by mass and 0.039% by mass, respectively, and the molar ratio of zirconium to fluorine was 1:3.

### Experimental Example 15

A battery I1 was produced in the same manner as in experiment 2 except that 0.65 g of magnesium nitrate hexahydrate (Mg(NO₃)₂.6H₂O) was used instead of erbium nitrate pentahydrate. The amount of adhesion of magnesium and the amount of adhesion of fluorine were 0.012% by mass and 0.019% by mass, respectively, and the molar ratio of magnesium to fluorine was 1:3.

### Experimental Example 16

A battery J1 was produced in the same manner as in experiment 2 except that 0.96 g of aluminum nitrate nonahydrate (Al(NO₃)₃.9H₂O) was used instead of erbium nitrate pentahydrate. The amount of adhesion of aluminum and the amount of adhesion of fluorine were 0.014% by mass and 0.029% by mass, respectively, and the molar ratio of aluminum to fluorine was 1:3.

### Experimental Example 17

A battery K1 was produced in the same manner as in experiment 11 except that lithium cobaltate particles including samarium hydroxide dispersed on and adhering to their surface (i.e., lithium cobaltate particles including samarium hydroxide dispersed on and adhering to their surface but including no fluorine adhering to the surface) were used as the positive electrode active material.

### Experimental Example 18

A battery L1 was produced in the same manner as in experiment 12 except that lithium cobaltate particles including neodymium hydroxide dispersed on and adhering to their surface (i.e., lithium cobaltate particles including neodymium hydroxide dispersed on and adhering to their surface but including no fluorine adhering to the surface) were used as the positive electrode active material.

### Experimental Example 19

A battery M1 was produced in the same manner as in experiment 13 except that lithium cobaltate particles including lanthanum hydroxide dispersed on and adhering to their surface (i.e., lithium cobaltate particles including lanthanum hydroxide dispersed on and adhering to their surface but including no fluorine adhering to the surface) were used as the positive electrode active material.

### Experimental Example 20

A battery N1 was produced in the same manner as in experiment 14 except that lithium cobaltate particles including zirconium hydroxide dispersed on and adhering to their surface (i.e., lithium cobaltate particles including zirconium hydroxide dispersed on and adhering to their surface but including no fluorine adhering to the surface) were used as the positive electrode active material.

### Experimental Example 21

A battery O1 was produced in the same manner as in experiment 15 except that lithium cobaltate particles including magnesium hydroxide dispersed on and adhering to their surface (i.e., lithium cobaltate particles including magnesium hydroxide dispersed on and adhering to their surface but including no fluorine adhering to the surface) were used as the positive electrode active material.

### Experimental Example 22

A battery P1 was produced in the same manner as in experiment 16 except that lithium cobaltate particles including aluminum hydroxide dispersed on and adhering to their surface (i.e., lithium cobaltate particles including aluminum hydroxide dispersed on and adhering to their surface but including no fluorine adhering to the surface) were used as the positive electrode active material.

### Experiment 1

For each of the above-produced batteries, the rate of suppression of cobalt dissolution after continuous charge was performed at 60° C. for 65 hours under the following conditions was examined, and the results for these batteries are shown in Table 1. The results for batteries A1 and A2, B1 to B3, C1 and C2, and D1 to D3 are shown in FIG. 2.

### [Charge Conditions]

Each battery was charged in an environment of 60° C. at a constant current of 1.0 It (750 mA) until the battery voltage reached 4.40 V and charged at a constant voltage of 4.40 V. The charge including the constant current charge and the constant voltage charge was performed for a total of 65 hours.

### [Measurement of Amount of Dissolution of Cobalt]

Each of the charged batteries was disassembled, and a negative electrode piece with a length of 2 cm and a width of 2 cm was cut from the negative electrode removed. The negative electrode piece was placed in EDX-7000 manufactured by Shimadzu Corporation, and X-ray fluorescence analysis was performed for quantification of elemental cobalt.

Batteries R1, R2, R3, R4, and R5 were produced in the same manner as in experiment 1 except that lithium cobaltates having average particle diameters of 7 μm, 10 μm, 16 μm, 23 μm, and 28 μm (lithium cobaltates with no rare earth elements and no fluorine adhering thereto) were each used as the positive electrode active material. Then the same procedure as described above was followed to obtain a negative electrode piece after continuous charge at 60° C. for 65 hours, and quantification of elemental cobalt was performed.

### [Computation of Rate of Suppression of Cobalt Dissolution]

For each of the batteries A1 and A2, B1 to B3, C1 and C2, D1 to D3, and E1 to P1, the rate of suppression of cobalt dissolution was computed using formula (1) below. In formula (1), the quantified amount of elemental cobalt in a battery is denoted by S, and the quantified amount of elemental cobalt in one of the batteries R1 to R5 in which the lithium cobaltate has the same average particle diameter as the lithium cobaltate in the above battery is denoted by T. For example, for the battery A1, the quantified amount of elemental cobalt in the battery A1 was used as S, and the quantified amount of elemental cobalt in the battery R1 was used as T to compute the rate of suppression of cobalt dissolution in the battery A1.

Rate of suppression of cobalt dissolution (%)=100−(S/T)×100 (1)

TABLE 1

| | Particle, diameter of | | Rate of suppression |
|---|---|---|---|
| | lithium cobaltate | Adhering | of cobalt dissolution |
| Battery | (μm) | element | (%) |
| A1 | 7 | Er + F | 33.1 |
| A2 | 10 | Er + F | 31.3 |
| B1 | 16 | Er + F | 9.1 |
| B2 | 23 | Er + F | 5.8 |
| B3 | 28 | Er + F | 8.1 |
| C1 | 7 | Er | 11.0 |
| C2 | 10 | Er | 8.3 |
| D1 | 16 | Er | 6.1 |
| D2 | 23 | Er | 4.7 |
| D3 | 28 | Er | 3.1 |
| E1 | 10 | Sm + F | 27.5 |
| F1 | 10 | Nd + F | 25.1 |
| G1 | 10 | La + F | 24.8 |
| H1 | 10 | Zr + F | 17.6 |
| I1 | 10 | Mg + F | 16.9 |
| J1 | 10 | Al + F | 16.9 |
| K1 | 10 | Sm | 9.9 |
| L1 | 10 | Nd | 9.5 |
| M1 | 10 | La | 8.1 |
| N1 | 10 | Zr | 6.7 |
| O1 | 10 | Mg | 6.2 |
| P1 | 10 | Al | 5.2 |

In each of the batteries A1 and A2 and the batteries B1 and B2, the lithium cobaltate used had an average particle diameter of 10 μm or less. As can be seen by comparing the batteries A1 and A2 in which erbium and fluorine adhered to the lithium cobaltate with the batteries B1 and B2 in which only erbium adhered to the lithium cobaltate, the dissolution of cobalt was significantly suppressed particularly in the batteries A1 and A2. This may be because of the following reason.

In the charged state, dissolution of cobalt from lithium cobaltate occurs. Particularly, when the average particle diameter of the lithium cobaltate is 10 m or less, the probability that lattice defects such as atomic vacancies and grain boundaries are present on the surface of the particles tends to be high. In this case, cobalt may easily dissolve through these lattice defects. However, when erbium and fluorine adhere to the lithium cobaltate having an average particle diameter of 10 μm or less, the adhering erbium and fluorine may allow dissolution of cobalt to be suppressed.

When only erbium adheres to the lithium cobaltate having an average particle diameter of 10 μm or less, dissolution of cobalt from the lithium cobaltate having an average particle diameter of 10 μm or less may not be suppressed sufficiently.

In each of the batteries B1 to B3 and the batteries D1 to D3, the lithium cobaltate used had an average particle diameter of larger than 10 μm. As can be seen by comparing the batteries B1 to B3 in which erbium and fluorine adhered to the lithium cobaltate with the batteries D1 to D3 in which only erbium adhered to the lithium cobaltate, no significant difference in the rate of suppression of cobalt dissolution was found. This may be because of the following reason.

In the charged state, dissolution of cobalt from lithium cobaltate occurs. When the average particle diameter of the lithium cobaltate is larger than 10 μm, the amount of dissolution of cobalt may not be as large as that when the average particle diameter is 10 μm or less. This may be the reason that the effect of suppressing dissolution of cobalt when erbium and fluorine adhere to the lithium cobaltate is the same as that when only erbium adheres to the lithium cobaltate.

In the above exemplary description, erbium and fluorine adhere to lithium cobaltate. However, when lithium cobaltate to which fluorine and at least one element selected from zirconium, titanium, aluminum, magnesium, and rare earth elements such as samarium, neodymium, and lanthanum adhere is used, the dissolution of cobalt may be suppressed because of the same reason as described above.

In the above Examples, lithium cobaltate was used as the positive electrode active material. However, also when a lithium transition metal oxide containing cobalt is used, dissolution of cobalt may be suppressed.

### REFERENCE SIGNS LIST

20 positive electrode active material
21 lithium-cobalt transition metal oxide particles
22 material containing at least one element selected from zirconium, titanium, aluminum, magnesium, and rare earth elements
23 material containing fluorine

1-8. (canceled)

9. A positive electrode active material for a nonaqueous electrolyte secondary battery, comprising a lithium transition metal oxide,
wherein a material containing at least one element selected from zirconium, titanium, aluminum, magnesium, and rare earth elements and a material containing fluorine adhere to the surface of the lithium transition metal oxide,
wherein the material containing at least one element selected from zirconium, titanium, aluminum, magnesium, and rare earth elements includes at least one compound selected from a hydroxide, an oxyhydroxide and a carbonate compound, and the material containing fluorine includes at least one compound selected from lithium fluoride, sodium fluoride, and potassium fluoride,
the lithium transition metal oxide contains cobalt, and
the lithium transition metal oxide has an average particle diameter of 10 μm or less.

10. The positive electrode active material for a nonaqueous electrolyte secondary battery according to claim 9, wherein the lithium transition metal oxide comprises LiCoO₂.

11. The positive electrode active material for a nonaqueous electrolyte secondary battery according to claim 9, wherein the molar ratio of the total amount of zirconium, titanium, aluminum, magnesium, and rare earth elements adhering to the surface of the lithium transition metal oxide to the total amount of fluorine adhering to the surface of the lithium transition metal oxide is 1:2 to 1:4.

12. The positive electrode active material for a nonaqueous electrolyte secondary battery according to claim 9, wherein the material containing at least one element selected from zirconium, titanium, aluminum, magnesium, and rare earth elements comprises rare earth elements and the material containing fluorine adhere to the surface of the lithium transition metal oxide.

13. A positive electrode for a nonaqueous electrolyte secondary battery, comprising the positive electrode active material for a nonaqueous electrolyte secondary battery according to claim 9, a conductive agent, and a binder.

14. The positive electrode for a nonaqueous electrolyte secondary battery according to claim 13, wherein the ratio of the positive electrode active material for a nonaqueous electrolyte secondary battery to the total mass of positive electrode active materials is 20% by mass or more.

15. The positive electrode active material for a nonaqueous electrolyte secondary battery according to claim 9, wherein the material containing at least one element selected from zirconium, titanium, aluminum, magnesium, and rare earth elements comprises at least one selected from neodymium, samarium, erbium, and lanthanum elements and the material containing fluorine adhere to the surface of the lithium transition metal oxide.

16. The positive electrode active material for a nonaqueous electrolyte secondary battery according to claim 9, wherein LiCoO₂ has an average particle diameter of 7 μm or less.
